(19) United States
(12) Patent Application Publication
(10) Pub. No.: US 2012/0012635 A1
(43) Pub. Date: Jan. 19, 2012

(54) STAPLER FOR PREVENTING SIMULTANEOUS DISPENSING OF MULTIPLE STAPLES

(76) Inventors: Barry Jaffe, Freeport, NY (US); Augustin Ruiz, Anaheim, CA (US)

(21) Appl. No.: 12/837,907

(22) Filed: Jul. 16, 2010

(51) Int. Cl. B25C 5/16; B23P 19/04; B25C 5/10

(52) U.S. Cl. 227/134; 227/139; 29/428

(57) ABSTRACT

Staplers and methods of stapling are described. The stapler includes a topsail configured to support a plurality of staples, the staples being slidably moveable on the topsail; a blade configured to drive an end staple of the plurality of staples out of the stapler and into an object to staple; a pusher configured to urge the plurality of staples on the topsail in a direction toward the blade; a finger configured to move between at least two positions by movement of the blade, a first position where the finger does not substantially counter action of the pusher, and a second position where the finger is engaged with the plurality of staples to substantially counter action of the pusher on the staples to keep the plurality of staples excluding the end staple away from the blade.

### FIELD

The present disclosure relates to a stapler and more particularly to a stapler for preventing simultaneous dispensing of multiple staples.

### BACKGROUND

In the discussion of the background that follows, reference is made to certain structures and/or methods. However, such references should not be construed as an admission that these structures and/or methods constitute prior art. Applicant expressly reserves the right to demonstrate that such structures and/or methods do not qualify as prior art.

Sod consists of grass and the part of the soil beneath the grass that is held together by the roots of the grass. Sometimes a piece of material is used to hold the sod together. When sod is laid on bare ground the sod needs to be tacked down to the ground to prevent the sod from moving so that there is a stable bed for the roots of the grass to grow into. Additionally, if the sod is not tacked down rain may create erosion problems between the sod and the ground. Tacking the sod to the ground is a laborious task where often a person may bend down and drive fastener through the sod and into the ground. This process of tacking the sod to the ground may be very laborious and expensive, which encourages workers to take short cuts that do not properly tack the sod to the ground. This may create environmental problems from erosion which may pollute local ecosystems and may result in the roots of the sod not growing into the bare ground which may result in the sod dying. Therefore, there is a need for a stapler of the type described herein.

### SUMMARY

Apparatus and methods are provided for stapling. A stapler includes a topsail configured to support a plurality of staples, the staples being slidably moveable on the topsail; a blade configured to drive an end staple of the plurality of staples out of the stapler and into an object to staple; a pusher configured to urge the plurality of staples on the topsail in a direction toward the blade; a finger configured to move between at least two positions by movement of the blade, a first position where the finger does not substantially counter action of the pusher, and a second position where the finger is engaged with the plurality of staples to substantially counter action of the pusher on the staples to keep the plurality of staples excluding the end staple away from the blade.

It is to be understood that both the foregoing general description and the following detailed description are exemplary and explanatory and are intended to provide further explanation of the invention as claimed.

### BRIEF DESCRIPTION OF THE DRAWING

The following detailed description can be read in connection with the accompanying drawings in which like numerals designate like elements and in which:

FIG. 1 illustrates an example of a stapler.

FIGS. 2 and 2A illustrate an example of a stapler and the operation of the blade.

FIG. 3 illustrates a stapler and the operation of the pusher.

FIGS. 4 and 5 illustrate an example of a stapler where the blade is beginning to engage the finger and the finger is in a first position.

FIGS. 6 and 7 illustrate an example of a stapler where the blade has engaged the finger and the finger is in a second position.

### DETAILED DESCRIPTION

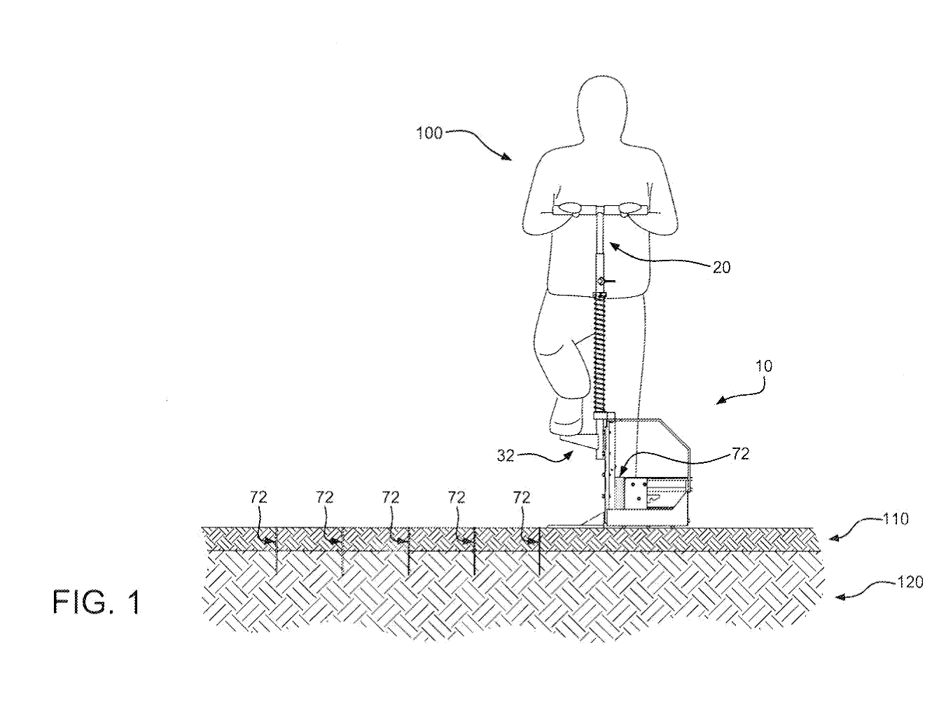

FIG. 1 illustrates an example of a stapler. A person 100 holds the handle 20 of a stapler 10 and presses the pedal 32 down to drive a staple 72 through the sod 110 and into the ground 120. The staple 72 tacks the sod 110 to the ground 120. In the embodiment illustrated, the stapler 10 does not bend the ends of the staples 72. The stapler 10 is portable so that a person 100 can lift the stapler 10 by the handle 20 and move the stapler 10 to the next location to drive in the next staple 72. In embodiments, the stapler 10 may have wheels to assist in moving the stapler 10. Stapling sod 110 down to the ground 120 is often very messy. There may be moisture and bits of the sod and ground may break off. A stapler 10 working in a such an environment could easily get clogged due to the moisture and bits of sod and ground, which can cause more than one staple to be presented for driving at the same time causing multiple staples to be dispensed at once, thus wasting staples, or causing the stapler 10 to jam.

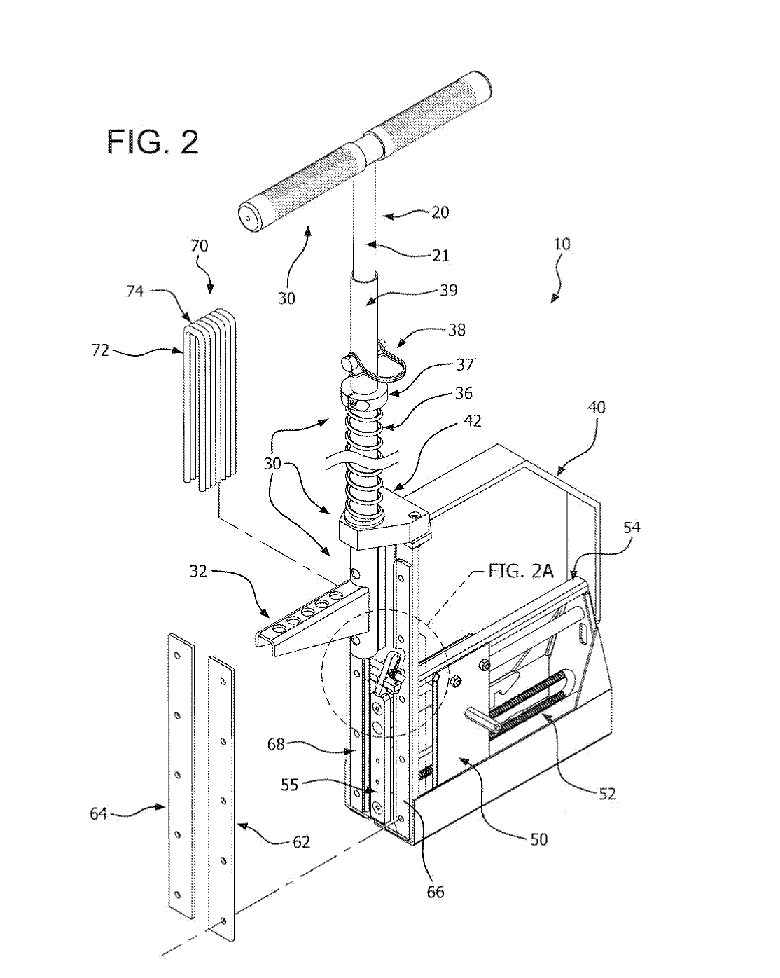

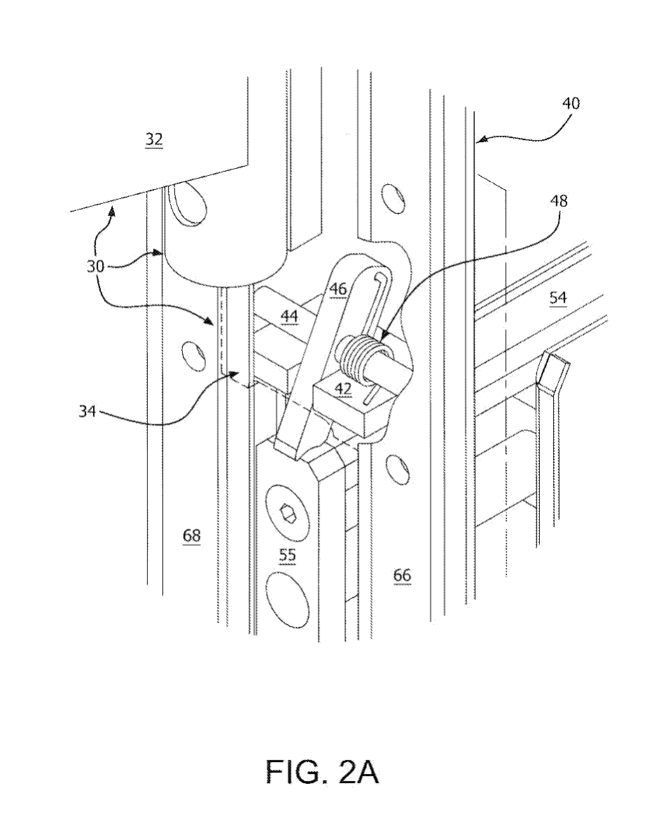

FIGS. 2 and 2A illustrate an example of a stapler and the operation of the blade. The stapler 10 includes a handle 20, a blade pedal assembly 30, a base assembly 40, a pedal guide 42, a pusher 50, a topsail 54, a front bracket 55, a pusher spring 52, front plates 62, 64, blade guides 66, 68, and staples (the staples are shown collectively as a group 70, with items 72, 74 representing individual staples within the group 70). The blade pedal assembly 30 includes a safety pin 38, a spring collar 37, a blade pedal spring 36, and a pedal 32. Referring to FIG. 2A, the blade 34 is shown in phantom. FIG. 2A also shows a finger bracket 42, a finger pin 44, a finger 46 and a finger spring 48. The parts of the stapler 10 can be made out of suitable materials.

The front plates 62, 64 are illustrated as removed from the stapler 10 to facilitate explanation. The front plates 62, 64 and the blade guides 66, 68 provide a guide in which the blade 34 can reciprocally travel. The pusher 50 which is explained in more detail below pushes on the staples 70 to urge the staples toward the blade 34 and against the front plates 62, 64. The finger 46 is rotatably attached to the base assembly 40 by a finger pin 44. Bracket 42 provides support. The bracket 42 has a cut out (not numbered) so that the finger 46 can rotate down and engage the staples 70. The staples 70 are illustrated as being out of the stapler 10 for clarity. The finger 46 has two positions: a first position where the finger 46 does not substantially counter the pusher 50, and a second position where the finger 46 is engaged with the staples 70 to substantially counter the pusher 50 to keep the staples 70, in particular staple 74 (but not 72) away from the blade 34 while the blade 34 is driving staple 72 out of the stapler 10. The finger spring 48 biases the finger 46 in an up position where the finger 46 does not engage the staples 70. The operation of the finger 46 is explained further below.

The blade pedal assembly 30 translates pressure on the pedal 32 to the blade 34 and provides support for the handle 20. In the example illustrated, the blade pedal assembly 30 also transmits hand pressure on the handle 20 from a person's hands to the blade 34. In the example illustrated, the handle 20 moves down as the pedal 32 (and blade 34) move down. Other configurations are possible so that the handle 20 would not move down as the pedal 32 moves down. The blade pedal assembly 30 goes through an opening in the pedal guide 42, which is attached to the base assembly 40. The safety pin 38 holds the handle 20 within guide tube 39. In embodiments, there are additional holes (not illustrated) in the handle shaft 21 so that the handle 20 height relative to guide tube 39 can be adjusted. The blade pedal spring 36 is held between the spring collar 37 and the pedal guide 42. The blade pedal spring 36 biases the blade pedal assembly 30 in an up position. The handle 20 is relatively stable for transporting the stapler 10 because the top of the blade 34 presses against the bottom of the pedal guide 42 and the blade pedal spring 36 biases the blade pedal assembly 30 in an up position.

In operation, the pedal 32 is pushed down by the foot of a person, which drives the blade pedal assembly 30 and the blade 34 attached to the blade pedal assembly 30 downward. In the embodiment illustrated, a person may also press down on the handle 20 with the hands to drive the blade 34 down, apart from or together with applying foot pressure to pedal 32. As the blade 34 is driven down the blade 34 engages the finger 46 which causes the finger 46 to engage the staples 70. The finger 46 is positioned so as to engage the staple 74 next to the end staple 72. As the blade 34 continues to be driven down the blade 34 engages the end staple 72 and drives the end staple 72 out of the stapler 10 and into the medium below the stapler 10, which may be sod, and then the stapler 10 further drives the staple 72 into the ground under the sod. The sod is thus tacked to the ground. Once the end staple 72 is driven out of the stapler 10, the person stops pushing on the pedal 32 and the bade 34 goes back up to its resting position due to the bias provided by the blade pedal spring 36. As the blade 34 goes up, the blade 34 no longer engages the finger 46. The finger 46 moves up due to the bias of the finger spring 48. Upward movement of finger 46 permits the staples 70 to move forward to permit staple 74 to replace the end staple 72 below the blade 34 for the next stroke. The staples 70 move forward under the force of the pusher 50 which is biased to move toward the blade and against the front guards 62, 64 by the pusher spring 52.

The finger 46 ensures that only the end staple 72 is pushed on by the blade 34 and that the staple 74 does not move into the position of the end staple 72 until after the end staple 72 has been driven out of the stapler 10. This may help to insure that the stapler 10 does not simultaneously push out two staples 72, 74, and this may help to prevent the stapler 10 from becoming jammed. In alternative embodiments, the finger 46 may substantially counter the push of the pusher 50 in other ways. For example, the finger 46 may engage other staples 70 since the staples 70 may be attached to one another, or the finger 46 may engage the pusher 50. In alternative embodiments, different structures other than a finger 46 may be used to substantially counter the push of the pusher 50.

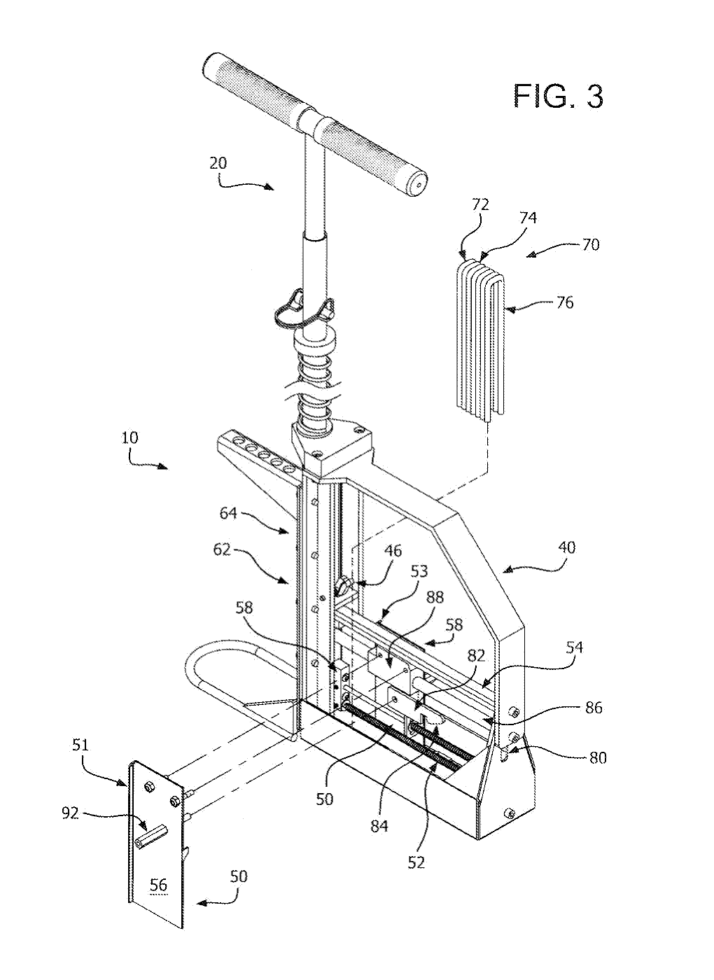

FIG. 3 illustrates a stapler and the operation of the pusher. The stapler 10 includes a base assembly 40, a pusher 50 with pusher plates 56, 58, a pusher spring 52, a topsail 54, a pusher holder assembly 58, pusher rider 82, slot 80, and a pusher rod 86. The pusher rider 82 includes an edge 84. Also illustrated are staples 70.

The topsail 54 supports the staples 70, shown for clarity as removed from the stapler 10. The pusher rod 86 provides a guide on which the pusher bushing 88 may slide back and forth. The bottom guide (not illustrated) provides a guide for the pusher plates 56, 58 on the opposite end from the pusher rod 86. The pusher rider 82 is pushed on by the pusher spring 52 and slides along the rod of the pusher holder assembly 58. The pusher rider 82 is connected to the pusher 50 and transmits the force of the pusher spring 52 through the pusher rider 82 to the pusher 50. The pusher rider 82 has a notch (not numbered) and a riding edge 84 for latching the pusher 50 onto the slot 80 while loading staples 70. The pusher 50 has a pusher handle 92 for pushing the pusher 50 into and out of a latched position where the notch is latched into the slot 80. The pusher 50 has pusher plates 54, 56 and front edges 51, 53. The pusher plates 54, 56 are fixedly attached to the pusher bushing 88 and the pusher rider 82. The pusher 50 pushes on the staples 70 to push them toward the blade (not illustrated) and against the front plates 62, 64.

In operation, the pusher 50 pushes the staples 70 along the front edge 51 and 53 of the pusher 50. The staples 70 are held between the pusher 50 and the front plates 62, 64. When the blade 34 is driven down into a staple 72, the finger 46 may substantially counter the force of the pusher 50 so that other staples 74, 76 are not pushed toward the staple 72 when the blade 34 is driving the staple 72 down. Once the blade 34 has substantially completed driving the staple 72 down, the finger 46 no longer substantially counters the force of the pusher 50 so that other staples 74 through 76 can be pushed against the front plates 62, 64.

The stapler 10 may be loaded with staples by a person grasping the pusher handle 92 and sliding the pusher 50 back so that the riding edge 84 rides up the slot 80 and the notch of the pusher rider 82 latches onto the slot 80. The stapler 10 may then be loaded with staples 70 by placing the staples 70 on the topsail 54. The person may then grasp the handle 92 and lift the pusher 50 so that the notch of the pusher rider 82 is released from the slot 80. The pusher 50 then slides forward from the bias of the spring 52 and holds the staples 70 against the front plates 62, 64.

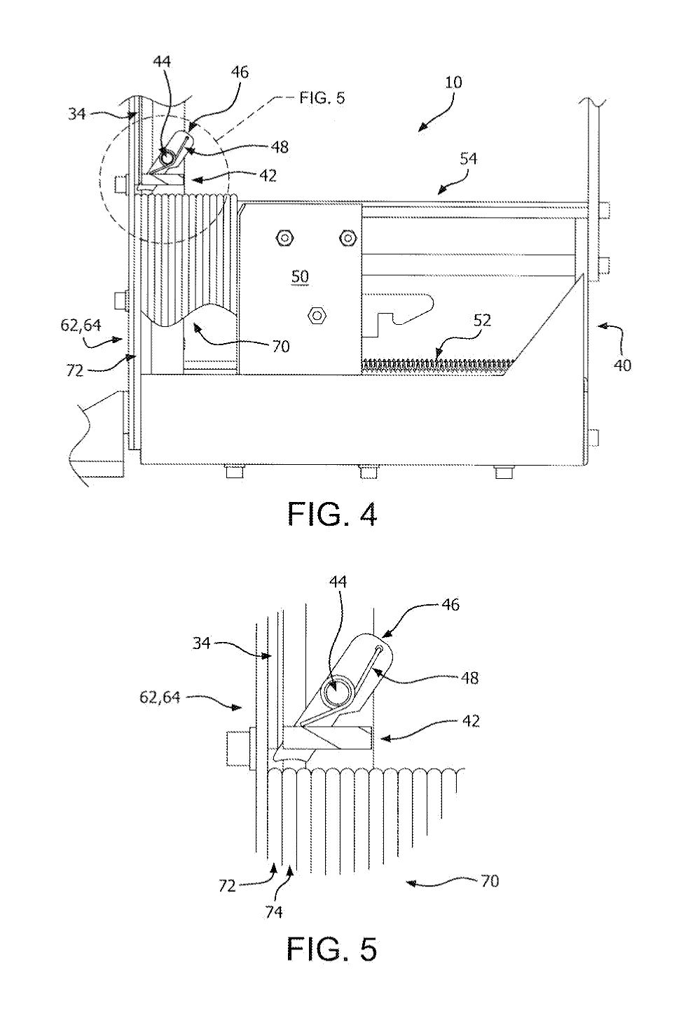

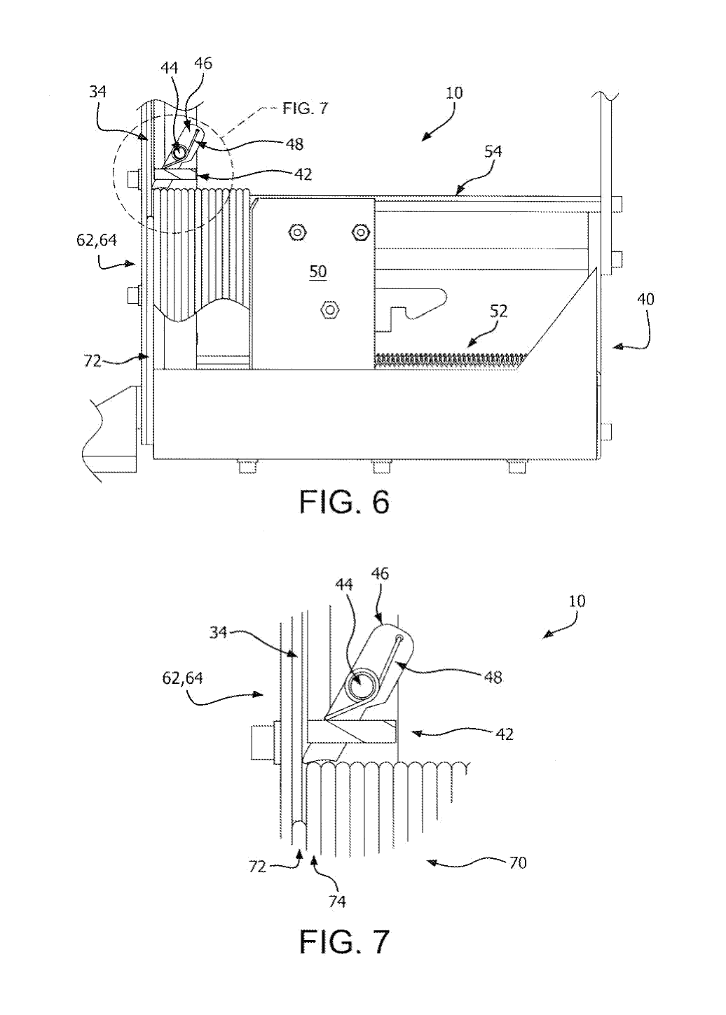

FIGS. 4 and 5 illustrate an example of a stapler where the blade is beginning to engage the finger and the finger is in a first position. The stapler 10 includes a blade 34, a finger pin 44, a finger 46, a finger spring 48, a pusher 50, a topsail 54, a pusher spring 52, front plates 62, 64, and staples 70, 72, 74. The finger 46 is rotatably attached to the base assembly 40 by the finger pin 44. The finger 46 is biased in an up position by the finger spring 48. The bracket 42 has a cut out (not illustrated) which permits the finger 46 to rotate to engage the staples 70, 72, 74. The pusher 50 pushes the staples 70, 72, 74 toward the front of the stapler 10 against the front plates 62, 64. As illustrated, the blade 34 is just above the finger 46, and the blade 34 may be considered to either be in the process of being driven down, in which case it is just about to push the finger 46 down as illustrated in FIGS. 6 and 7 and engage the staple 72, or the blade 34 may be in the process of returning up after having driven a staple 72 out of the stapler 10, in which case the blade 34 will have just released the finger 46 to permit the finger 46 to return to a first position where the finger 46 is not substantially countering the force of the pusher 50.

FIGS. 6 and 7 illustrate an example of a stapler where the blade has engaged the finger and the finger is in a second position. The finger 46 is rotatably attached to the base assembly 40 by the finger pin 44. The finger 46 is biased in an up position by the finger spring 48. The bracket 42 has a cut out (not illustrated) which permits the finger 46 to rotate to engage the staples 70, 72, 74. The pusher 50 pushes the staples 70, 72, 74 toward the front of the stapler 10. As illustrated, the blade 34 has pushed the finger 46 down into a second position where the finger 46 engages the staple 74 next to the end staple 72 to substantially counter the bias of the pusher 50 for the group of staples 70. By substantially countering the bias of the pusher 50, the staples 70, 74 are held back from the blade 34. This ensures that staple 74 is not engaged by the blade 34 and permits the blade 34 to act only on the staple 72. As illustrated, the blade 34 has pushed the staple 72 down to have partially driven the staple 72 out of the stapler 10. Once the blade 34 has driven the staple 72 completely out of the stapler 10, the blade 34 returns to a location above the finger 46 so that the finger 46 no longer substantially counters the bias of the pusher 50 on the staples 70, 74 and the staples 70, 74 are then pushed by the pusher 50 against the front guard, (so that staple 74 is ready to be driven out of the stapler 10 by the blade 34.

In alternative embodiments, the finger may be pushed on not directly by the blade but by the action of pushing the pedal. For example, another piece could move with the action of the pedal and push on the finger. Additionally, the finger may be biased down. In alternative embodiments, the finger may be touching the staples even when the finger is not substantially countering the push of the pusher. In alternative embodiments, the blade need not be driven directly by the action of the pedal. For example, the pedal may be pressed down to bias a spring and then once the pedal is pressed down passed a certain point the tension in the spring may be released to drive the blade down.

Although described in connection with preferred embodiments thereof, it will be appreciated by those skilled in the art that additions, deletions, modifications, and substitutions not specifically described may be made without departing from the spirit and scope of the invention as defined in the appended claims.

What is claimed is:

1. A stapler, comprising:
a topsail configured to support a plurality of staples, the staples being slidably moveable on the topsail;
a blade configured to drive an end staple of the plurality of staples out of the stapler and into an object to staple;
a pusher configured to urge the plurality of staples on the topsail in a direction toward the blade;
a finger configured to move between at least two positions by movement of the blade, a first position where the finger does not substantially counter action of the pusher, and a second position where the finger is engaged with the plurality of staples to substantially counter action of the pusher on the staples to keep the plurality of staples excluding the end staple away from the blade.

2. The stapler of claim 1, wherein the blade is configured to push the finger from the first position to the second position as the blade is moved to drive the end staple.

3. The stapler of claim 2, wherein the blade is further configured to release the finger so that the finger moves from the second position to the first position as the blade is retracted after having driven the end staple out of the stapler.

4. The stapler of claim 1, wherein the finger is disposed to engage the plurality of staples on a top surface of the plurality of staples.

5. The stapler of claim 1, wherein the finger is pivotably attached to a support above the topsail and biased by a torsion spring to be in the first position.

6. The stapler of claim 1, wherein the object to staple is a piece of sod.

7. The stapler of claim 6, wherein the stapler is configured to tack the end staple through the piece of sod into a ground.

8. The stapler of claim 1, further comprising:
a housing configured to support the topsail;
a handle attached to a top of the housing; and
a pedal attached to a shaft assembly slidably attached to the housing and attached to the blade and configured to be slidably moveable by application of force from a foot from a first position to a second position wherein the blade is configured to drive the end staple in the object to be stapled as the shaft is slidably moved from the first position to the second position, and wherein the shaft is biased to be in the first position.

9. The stapler of claim 8, wherein the blade is configured to push the finger from the first position to the second position as the pedal is moved from the first position to the second position.

10. The stapler of claim 1, wherein each of the plurality of staples are at least three inches long, and the handle is configured to be long enough so that the stapler can sit on the ground and be moved by a normal sized person using the handle without having to bend over.

11. A method of stapling using a stapler, the method comprising:
pushing on a plurality of staples toward an end staple with a pusher;
moving a pedal down toward an object to staple;
substantially countering the push of the pusher on the plurality of staples;
moving a blade to engage the end staple and driving the end staple into the object to staple; and
retracting the blade and stopping substantially countering the push of the pusher of the plurality of staples.

12. The method of stapling according to claim 11, wherein the step of substantially countering the force of the pusher occurs in response to movement of the blade to engage the end staple.

13. The method of stapling according to claim 11, where in the step of stopping substantially countering the force of the pusher occurs in response to retraction of the blade.
